(19) United States
(12) Patent Application Publication
(10) Pub. No.: US 2003/0128853 A1
(43) Pub. Date: Jul. 10, 2003

(54) Broadband transducer controlled by magnetic field coupling

(76) Inventor: Po-An Chuang, Taipei (TW)

Correspondence Address: David E Dougherty, Dennison Schultz & Dougherty, 612 Crystal Square 4, 1745 Jefferson Davis Highway, Arlington, VA, 22202, US

(21) Appl. No.: 10/035,310

(22) Filed: Jan. 4, 2002

(51) Int. Cl. H04R 3/00; H04R 1/00

(52) U.S. Cl. 381/117; 381/111; 381/401; 381/396

(57) ABSTRACT

A broadband transducer controlled by magnetic field coupling, the transducer has signal volume control of a hi-fi set that is achieved by means of variable resistance originally achieved instead by means of a magnetic field coupler, wherein, the magnetic field coupler has a primary coil and a secondary coil with an adjustable gap therebetween, an adjusting rod is provided in the gap for adjustment and control; thereby, magnetic resistance is controlled for controlling volume of sounds; using of low voltage amplifying saves energy source and lowers cost of production, and makes an amplifier have an ideal acoustic effect able to give sweet sounds such as is done with a vacuum tube type hi-fi set and to give pushout power such as is done with a transistor type hi-fi set.

### BACKGROUND OF THE INVENTION

1. Field of the Invention

The present invention is related to an improvement on volume control of a hi-fi set, and especially to a broadband transducer controlled by magnetic field coupling which makes sounds sweet, wherein, the input and output signals are controlled by magnetic field coupling to get the effect of broadband transmission (5^{˜}200 KHz), volume of sounds can be adjusted by changing amplification with magnetic impedance, the transducer can have both the advantages of the vacuum tube type and the transistor type hi-fi sets.

2. Description of the Prior Art

Conventional amplifiers for hi-fi sets include two kinds, the vacuum tube type and the transistor type hi-fi sets, they have their respective advantages and disadvantages; volume control VC of a conventional amplifier is as shown in FIG. 1, and is achieved by means of variable resistance VR of 10 k^{˜}100 kΩ. Volume is controlled by attenuation when the source of signals is input. High impedance simultaneously makes attenuation of the weak 0.5 V^{˜}2V voltage and electric current, so that a transistor type hi-fi set which can simultaneously amplify “V” and “I” to activate loudspeakers is unable to get plump, smooth and sweet sounds.

If one wants to output sounds with sweet quality, a vacuum tube type hi-fi set must be used; it has a well known good effect of treating sounds. The vacuum tube type hi-fi set uses vacuum tubes for amplifying; 4^{˜}8Ω loudspeakers will always be in the state of high voltage if they are activated during working, it is relatively difficult to make insulation when facing the high voltage, exhausting of an energy source of high heat makes limited life which is about 3000^{˜}5000 hrs., makes maintenance difficult, and makes power small (power is in direct proportion to heat), thereby, their cost of production is high, this renders their selling promotion difficult,

And more, most amplifiers use capacitive crosslinking, their entire ranges of frequency response are not wide enough, and their signal transmission will result phase differences, time differences stage by stage make the phase differences more evident and make the sound output not delighted.

Summarily, the techniques now available make sound adjustment and control by variant electric resistances, their cost of production is low, their quality of sounds is relatively distorted though; if one wants to elevate the quality of sounds, electric circuits of vacuum tube type hi-fi sets of high cost shall be used. There has been no perfect solution, but practically, it is necessary to elevate quality of outputting sounds for expensive high-class hi-fi sets.

Moreover, acoustic output in the past time must had different pushout for various horns with different sensitivities, once some horns for a hi-fi set are changed, the hi-fi set is unable to adapt itself to very fast, the pushout must be recalculated; otherwise, its outputting sounds will be unable to be coordinated, and this is one of the defects thereof.

In view of this, the inventor of the present invention studied and experimented hardly, and lastly developed the present invention with success.

### SUMMARY OF THE INVENTION

The primary object of the present invention is to provide a broadband transducer controlled by magnetic field coupling which makes sounds sweet, wherein, the input and output signals are controlled by magnetic field coupling to render volume of sounds to be adjusted by changing amplification with magnetic impedance, to get both the advantages of the vacuum tube type and the transistor type hi-fi sets without the defects resided in both types of hi-fi sets.

The secondary object of the present invention is to provide an acoustic output of which the input signals are controlled by magnetic field coupling to get the effect of broadband transmission (5^{˜}200 KHz).

Another object of the present invention is to design magnetic field coupling to have several modules of different amplifications, so that the present invention can make easy matching and obtain suitable amount of pushout for various horns of different sensitivities.

To achieve the above stated objects, the broadband transducer controlled by magnetic field coupling of the present invention mainly has signal volume control of a hi-fi set that is achieved by means of variable resistance originally achieved instead by means of a magnetic field coupler. The magnetic field coupler has a primary coil and a secondary coil with an adjustable gap therebetween, an adjusting rod is provided in the gap for adjustment and control; thereby, magnetic resistance can be controlled for controlling volume of sounds. Using of low voltage amplifying can save energy source and lower cost of production, and can make an amplifier have an ideal acoustic effect able to give sweet sounds such as is done with a vacuum tube type hi-fi set and to give pushout power such as is done with a transistor type hi-fi set.

The present invention will be apparent after reading the detailed description of the preferred embodiment thereof in reference to the accompanying drawings.

### BRIEF DESCRIPTION OF THE DRAWINGS

FIG. 1 shows a sound volume adjusting electric circuit diagram of a conventional transistor amplifier;

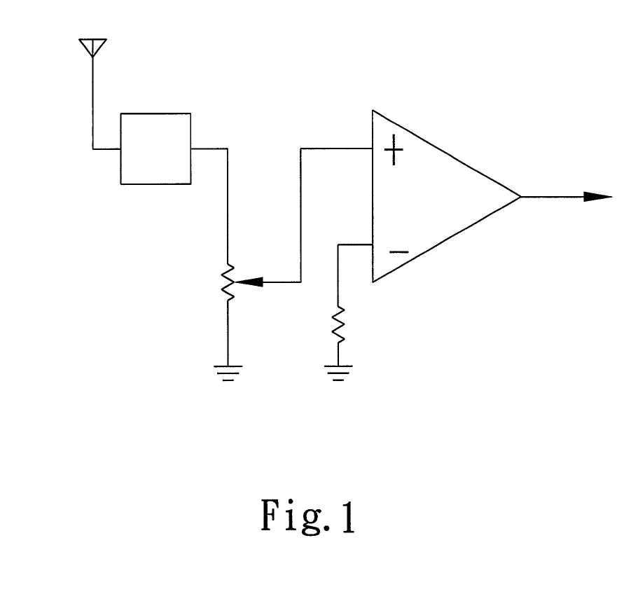

FIG. 2 shows a sound volume adjusting electric circuit diagram of the present invention;

FIG. 3 shows an electric circuit diagram of the present invention, wherein, outputting signals are controlled by magnetic field coupling;

FIG. 4 shows an electric circuit diagram of the present invention, wherein, magnetic field coupling is done by module arrangement;

FIG. 5 is a schematic view showing the multiplying powers made from mating modules.

### DETAILED DESCRIPTION OF THE PREFERRED EMBODIMENT

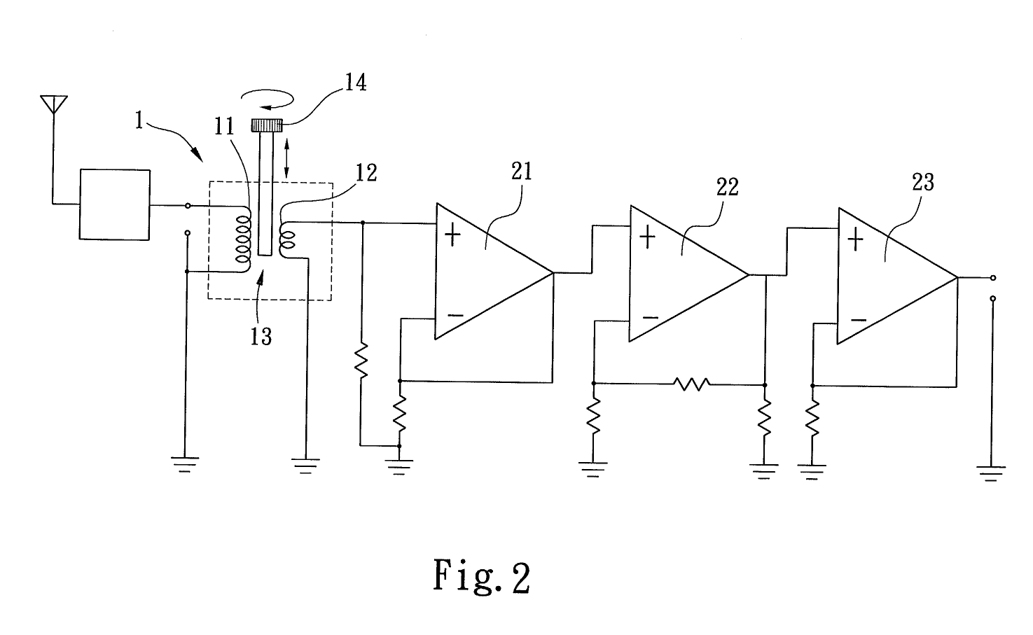

Referring firstly to FIG. 2, the broadband transducer controlled by magnetic field coupling of the present invention mainly has signal volume control of a hi-fi set that is achieved by means of variable resistance originally achieved instead by means of a magnetic field coupler 1.

Wherein, the magnetic field coupler 1 has a primary coil 11 and a secondary coil 12 with an adjustable gap 13 therebetween, an adjusting rod 14 is provided in the gap 13 for adjustment and control.

Thereby, the combined acoustic effect can be adjusted and controlled with the adjusting rod 14, to change the amount of the adjustable gap 13 from shutting to opening can control change of the amount of magnetic resistance of the primary coil 11 and the secondary coil 12 for controlling volume of sounds.

In practicing, the magnetic field coupler 1 can be serially connected on the rear end thereof to a coupler stage 21, an amplifier stage 22 and a coupler stage 23. The primary coil 11 of the magnetic field coupler 1 with a multi-circle high impedance of about 50^{˜}5 kΩ can make good matching with signals; and the secondary coil 12 can get a low voltage reduced by same ratio and a current amplified by the same ratio, that is a music signal with an extremely high density of which the effect is same as that obtained from an output transformer of a vacuum tube type hi-fi set. The signal then is amplified by a transistor to obtain a plump, smooth and sweet sound as that obtained from an output transformer of a vacuum tube type hi-fi set, and can have a larger output power.

At the first time of signal input of the designing of the present invention, magnetic field coupling rather than variable resistance VR is used, thereby, the voltage of the signal source can be compressed to a small one, namely ½^{˜}1/10 of the voltage. At the same time, its current can be amplified for 2^{˜}10 folds, this is a music signal source with an extremely high density. The useless direct current portion is filtered, the “V” and “I” of the front and the rear stages of the transistor are amplified simultaneously, until they reach an adequate voltage as can activate the loudspeakers. 28.3 V is just adequate for push 8Ω loudspeakers to 100 W. The largest advantage is that, all the processes of amplifying of the circuit are proceeded to under low voltages, there will be no worry of safety as is the case of a conventional vacuum tube type hi-fi set that may result bad insulation from high voltage, nor noise will be generated when a variable resistor has inferior contact.

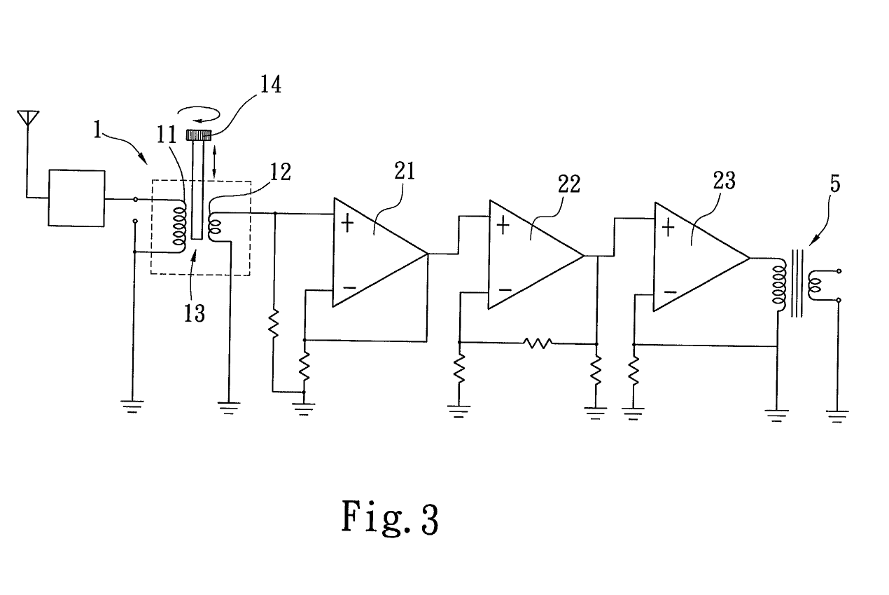

A preferred situation of application is shown in FIG. 3, another magnetic field coupler 5 is also connected to the output end of the present invention. The output and input signals of the entire circuit are all controlled by magnetic field coupling and high frequency skin effect to get a balance of loudness of high and low frequencies, In this way, not only the sound signals can have the above stated advantages, but also the entire amplified output does not use capacitive crosslinking and the preceding non-signal direct current and noise can be filtered off with the coil during all the IC amplifying as well as transistor amplifying, and only the sound signal alternating currents are amplified. Thereby, excellent quality of sound can be obtained in acoustic output, and an effect of broadband transmission of 5^{˜}200 KHz can be acquired. This can be widely applied to the modern video and acoustic equipment such as a DVD, an SACD etc.; and one thing especially worth mentioning, by discovery in practical manufacturing, such effective improved circuit can unexpectedly save more than 50% electric power as compared to conventional ones, there will be no phenomenon of overheating even when a hi-fi set is continuously turned on for 4^{˜}5 days.

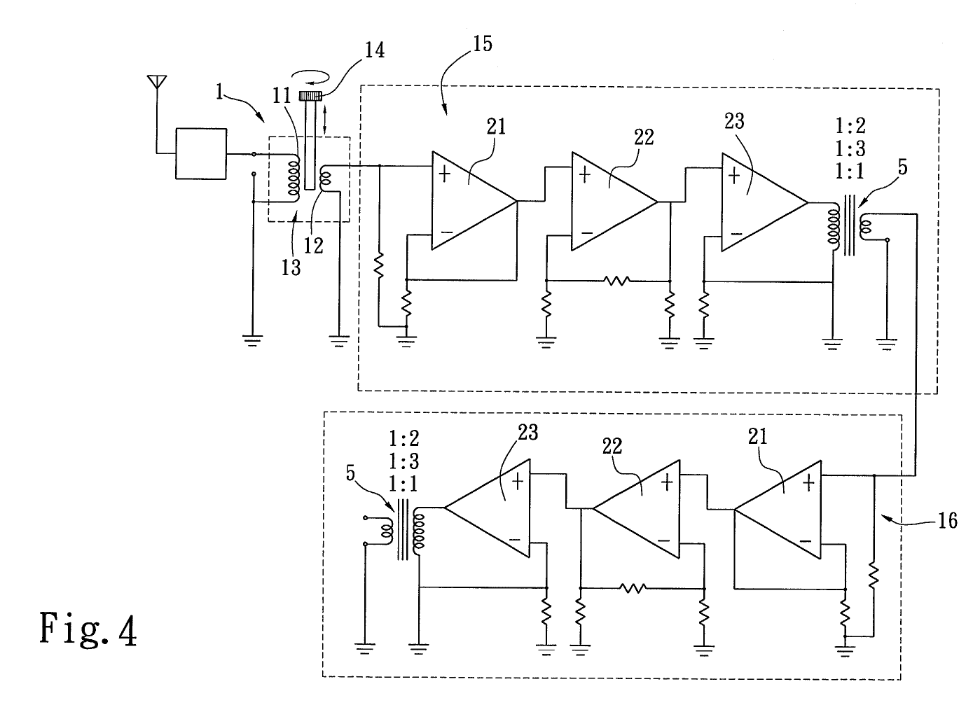

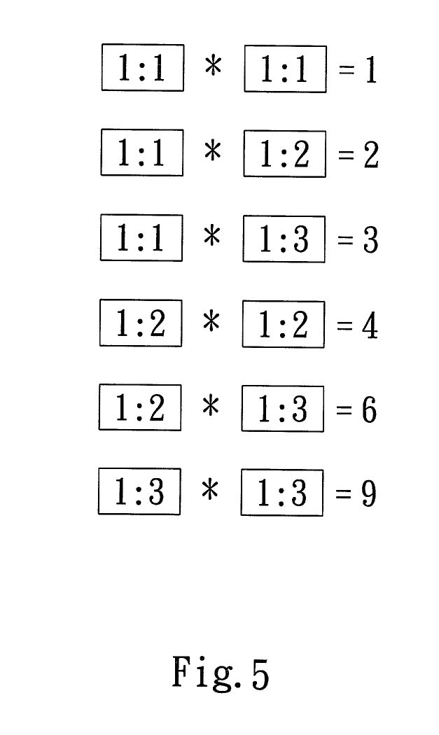

And referring to FIG. 4, the present invention can also divide the output circuit and the magnetic field coupler 5 into two mutually serially connected circuit modules 15 and 16 respectively having an independent coil, the circuit modules 15 and 16 have three kinds of specifications of electric current amplifications 1:2:3, but their voltage amplifications are same, so that they can be agilely mated in combinations in application. As shown in FIG. 5, they can get by multiplication a plurality of sound signal compression and amplification ratios such as 1, 2, 3, 4, 6 and 9 folds, hence after simple selection and mating, they can be used for various horns of different high and low sensitivities, in order to get the most suitable pushout.

Accordingly, the present designing sufficiently utilizes signal sources, and uses low voltage amplification, it can save energy source and lower cost of production to thereby get an ideal acoustic amplifier to give sweet sounds such as is done with a vacuum tube type hi-fi set and to give a pushout power such as is done with a transistor type hi-fi set. Wherein, the mode using magnetic field coupling may be more expensive than that using variable resistance, but the effect of dealing with the quality of sounds thereof is evidently improved, and its expense is nothing as compared with a vacuum tube type hi-fi set; and the acoustic effect obtained is not inferior to conventional cases, subsequent dealings with signals are simpler and safer, life of use will be evidently elongated. Therefore, for those more expensive high class hi-fi sets, even when the mode using magnetic field coupling will have some cost of parts increased as compared with that using variable resistance, the cost as a whole is merely no influence, while the quality of sounds of acoustic outputs evidently has gain effectively, and the mode using magnetic field coupling is worthwhile.

The present invention has been stated as above, those skilled in this art can understand and get the objects stated above of my invention which is industrially valuable.

The above stated are only for illustrating a preferred embodiment of the present invention. It will be apparent to those skilled in this art that various modifications or changes can be made to the elements of the present invention without departing from the spirit and principle of this invention. Accordingly, all such modifications and changes also fall within the scope of the appended claims.

What is claimed is:

1. A broadband transducer controlled by magnetic field coupling, said transducer has signal volume control of a hi-fi set that is achieved by means of variable resistance originally achieved instead by means of a magnetic field coupler, wherein, said magnetic field coupler has a primary coil and a secondary coil with an adjustable gap therebetween, an adjusting rod is provided in said gap for adjustment and control; thereby, magnetic resistance is controlled to control volume of sounds; using of low voltage amplifying saves energy source and lowers cost of production, and gives an amplifier an ideal acoustic effect able to give sweet sounds such as is done with a vacuum tube type hi-fi set and to give pushout power such as is done with a transistor type hi-fi set.

2. A broadband transducer controlled by magnetic field coupling as in claim 1, wherein,
said primary coil of said magnetic field coupler has a multi-circle high impedance of about 50^{˜}5 kΩ being adapted to making good matching with a signal source; and said secondary coil is adapted to getting a low voltage reduced by same ratio and an electric current amplified by the same ratio.

3. A broadband transducer controlled by magnetic field coupling as in claim 2, wherein,
the voltage of said signal source is compressed to a small one, namely ½^{˜}1/10 of said voltage, at the same time, the current of said signal source is amplified for 2^{˜}10 folds.

4. A broadband transducer controlled by magnetic field coupling as in claim 2, wherein,
said magnetic field coupler is serially connected on the rear end thereof to a coupler stage, an amplifier stage and another coupler stage; all the processes of amplifying are proceeded to under low voltages for amplifying voltage “V” and current “I”, so that 28.3 V is just adequate for push 8Ω loudspeakers to 100 W.

5. A broadband transducer controlled by magnetic field coupling as in claim 4, wherein,
a magnetic field coupler is also connected to the output end of said hi-fi set, the output and input signals of an entire circuit are all controlled by magnetic field coupling and high frequency skin effect to get a balance of loudness of high and low frequencies, in this way, an effect of broadband transmission of 5^{˜}200 KHz is acquired.

6. A broadband transducer controlled by magnetic field coupling as in claim 5, wherein,
said magnetic field coupler of said circuit at said output end of said hi-fi set is divided into two mutually serially connected circuit modules, said circuit modules are selected from those having same voltage amplifications and different electric current amplifications, and are mutually mated in combinations in multiplying powers.

7. A broadband transducer controlled by magnetic field coupling as in claim 6, wherein,
said circuit modules each is a single circle, and have three kinds of specifications of electric current amplifications 1:2:3, so that they are mated in combinations in application to get by multiplication a plurality of sound signal compression and amplification ratios of 1, 2, 3, 4, 6 and 9 folds.
